(19) United States
(12) Patent Application Publication
(10) Pub. No.: US 2008/0159252 A1
(43) Pub. Date: Jul. 3, 2008

(54) METHOD OF COORDINATED TRANSMISSION FOR BROADCAST-MULTICAST SERVICES IN HIGH DATA RATE NETWORKS

(76) Inventors: QI BI, Morris Plains, NJ (US); YIFEI YUAN, Livingston, NJ (US)

Correspondence Address: TERRY D. MORGAN;Williams, Morgan & Amerson, P.C., Suite 1100, 10333 Richmond, Houston, TX, 77042, US

(21) Appl. No.: 11/618,185

(22) Filed: Dec. 29, 2006

(51) Int. Cl. H04J 3/00

(52) U.S. Cl. 370/345

(57) ABSTRACT

A method is provided for coordinating transmissions from a base station in a high-speed wireless communications system. The method comprises targeting a transmission from a base station into a first sector of a cell during a first selected portion of a communications period; targeting a transmission from the base station into a second sector of the cell during a second selected portion of a communications period; and targeting a transmission from the base station into a third sector of the cell during a third selected portion of a communications period.

### BACKGROUND OF THE INVENTION

1. Field of the Invention

This invention relates generally to telecommunications, and, more particularly, to wireless communications.

2. Description of the Related Art

In the field of wireless telecommunications, such as cellular telephony, a system typically includes a plurality of base stations distributed within an area to be serviced by the system. Various users within the area, fixed or mobile, may then access the system and, thus, other interconnected telecommunications systems, via one or more of the base stations. Typically, a mobile device maintains communications with the system as the mobile device passes through an area by communicating with one and then another base station, as the user moves. The mobile device may communicate with the closest base station, the base station with the strongest signal, the base station with a capacity sufficient to accept communications, etc.

Wireless telephone systems employ a variety of communications standards, including, more recently, a broadband data standard commonly known as cdma 2000 Evolution—Data Optimized (EV-DO). EV-DO has dramatically increased the system capacity. In particular, broadcast-multicast service (BCMCS) enables operators to provide a variety of high speed applications more efficiently than by using traditional unicast or point-to-point mode of communication. One example of an application that would benefit from the high speed offered by BCMCS is a group call using Voice over Internet Protocol (VoIP). Such a call may be established, for example, using popular “walkie-talkie” techniques where speech from a user controlling a communication “floor” is distributed to predefined or ad-hoc talk group members by a special server.

In a conventional EV-DO unicast mode, ACK/NACK signaling from a mobile device can terminate Hybrid ARQ retransmission early, and thus improve transmission efficiency in fading channels. In BCMCS, however, there is no such fast feedback mechanism available, because mobile devices do not need to maintain a continuous Reverse Link connection to the access network. In some applications, MAC layer Reed-Solomon codes may be used to improve performance, however, these codes introduce a substantial delay that does not meet the requirements of latency-sensitive applications such as VoIP.

### SUMMARY OF THE INVENTION

In one aspect of the instant invention, a method is provided for controlling a communications system. The method comprises targeting a transmission from a base station into a first sector of a cell during a first selected portion of a communications period; targeting a transmission from the base station into a second sector of the cell during a second selected portion of a communications period; and targeting a transmission from the base station into a third sector of the cell during a third selected portion of a communications period.

### BRIEF DESCRIPTION OF THE DRAWINGS

The invention may be understood by reference to the following description taken in conjunction with the accompanying drawings, in which like reference numerals identify like elements, and in which:

FIG. 1A is a block diagram of a communications system, in accordance with one embodiment of the present invention;

FIG. 1B is a stylistic representation of a region in which the communications system of FIG. 1A may be employed;

FIG. 2 depicts a block diagram of one embodiment of a Base station and a mobile device used in the communications system of FIG. 1;

FIG. 3 is an enlarged view of a portion of FIG. 1B;

FIG. 4 is a timing diagram illustrating transmissions into a plurality of sectors of a cell;

FIG. 5 is a chart of a cumulative distribution function (CDF) of an SNR of a mobile device; and

FIG. 6 is a chart of the required SNR for different data rates.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

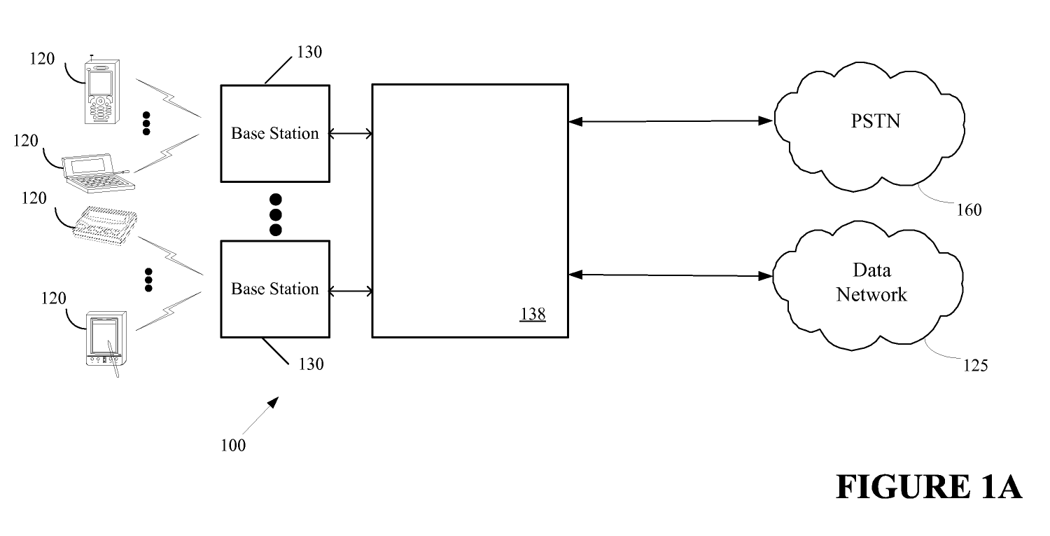

Turning now to the drawings, and specifically referring to FIG. 1A, a communications system 100 is illustrated, in accordance with one embodiment of the present invention. For illustrative purposes, the communications system 100 of FIG. 1A is a wireless telephone system that employs a broadband data standard commonly known as cdma 2000 Evolution—Data Optimized (EV-DO), although it should be understood that the present invention may be applicable to other systems that support data and/or voice communication. The communications system 100 allows one or more mobile devices 120 to communicate with a data network 125, such as the Internet, and/or a public telephone system (PSTN) 160 through one or more base stations 130 and additional circuitry 138, such as a Radio Network Controller (RNC). The mobile device 120 may take the form of any of a variety of devices, including cellular phones, personal digital assistants (PDAs), laptop computers, digital pagers, wireless cards, and any other device capable of accessing the data network 125 and/or the PSTN 160 through the base station 130.

Thus, those skilled in the art will appreciate that the communications system 100 enables the mobile devices 120 to communicate with the data network 125 and/or the PSTN 160. It should be understood, however, that the configuration of the communications system 100 of FIG. 1A is exemplary in nature, and that fewer or additional components may be employed in other embodiments of the communications system 100 without departing from the spirit and scope of the instant invention.

As is illustrated in FIG. 1B, a region 170 to be serviced by the system 100 is separated into a plurality of cells 175-181, each cell typically being associated with a separate base station 130. Typically, each cell has a plurality of adjacent neighboring cells. For example, the cell 175 has six neighboring cells 176-181 such that a mobile device 120 entering the cell 175 may travel from one of the neighboring cells 176-181. Thus, a mobile device 120 may, at any given time, receive communications from a base station 130 located in its current cell, as well as communications from a base station 130 located in one or more neighboring cells 176-181, particularly when the mobile device 120 is located at or near a border of two adjacent cells.

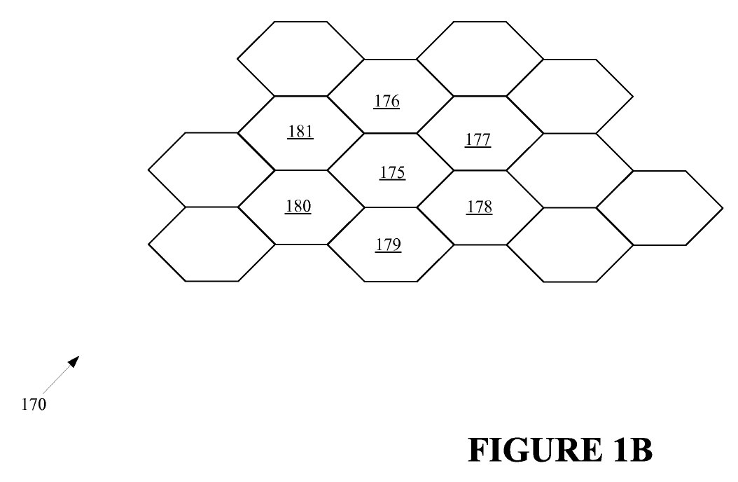

Referring now to FIG. 2, a block diagram of one embodiment of a functional structure associated with an exemplary base station 130 and mobile device 120 is shown. The base station 130 includes an interface unit 200, a controller 210, an antenna 215 and a plurality of channels: such as a shared channel 220, a data channel 230, and a control channel 240. The interface unit 200, in the illustrated embodiment, controls the flow of information between the base station 130 and upstream circuitry, such as a radio network controller (not shown). The controller 210 generally operates to control both the transmission and reception of data and control signals over the antenna 215 and the plurality of channels 220, 230, 240 and to communicate at least portions of the received information to the RNC via the interface unit 200.

The mobile device 120 shares certain functional attributes with the base station 130. For example, the mobile device 120 includes a controller 250, an antenna 255 and a plurality of channels: such as a shared channel 260, a data channel 270, and a control channel 280. The controller 250 generally operates to control both the transmission and reception of data and control signals over the antenna 255 and the plurality of channels 260, 270, 280.

Normally, the channels 260, 270, 280 in the mobile device 120 communicate with the corresponding channels 220, 230, 240 in the base station 130. Under the operation of the controllers 210, 250, the channels 220, 260; 230, 270; 240, 280 are used to effect a controlled scheduling of communications from the mobile device 120 to the base station 130.

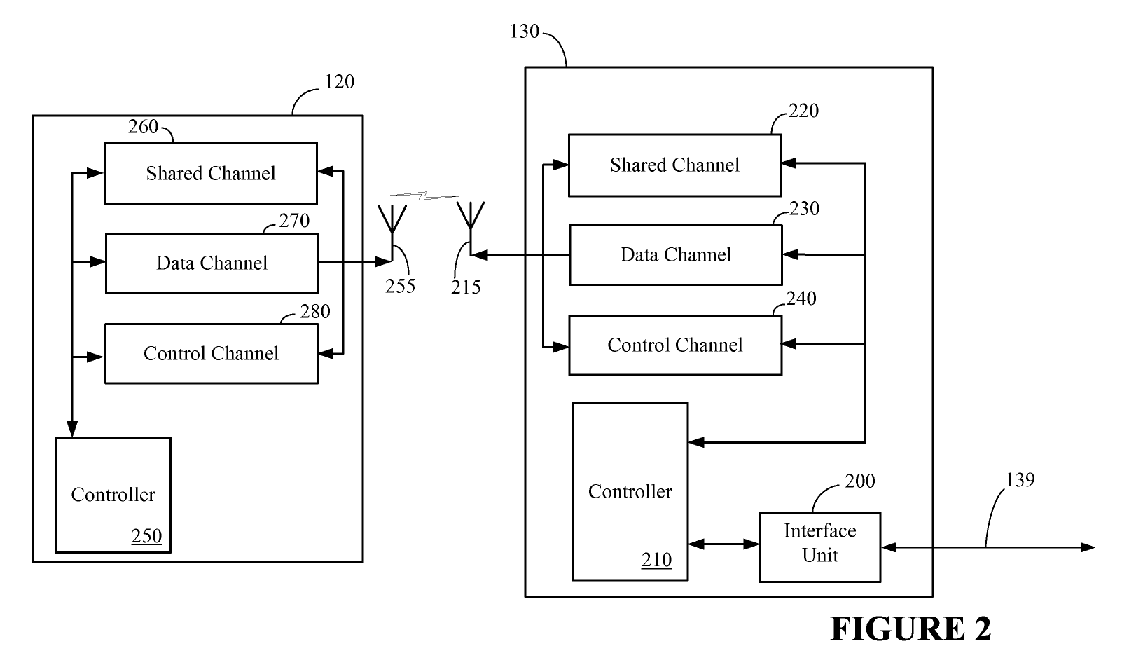

Turning now to FIG. 3, an exemplary portion of the region 170 illustrating cells 175-177 in greater detail is shown. In particular, each of the cells 175-177 is stylistically shown as being comprised of a plurality of sections or sectors. In one embodiment of the instant invention, each cell is comprised of three sections, such as 175(1), 175(2), 175(3), into which each associated base station 130 selectively targets its transmissions. The timing of the transmissions by the base stations 130 into these three sections 175(1), 175(2), 175(3) may be controlled to advantageously reduce interference experienced by a mobile device 120 from neighboring base stations 130. For example, a mobile device 120 located near the border of cells 175 and 176 may receive transmissions from base stations 130 located at or near the center of each of these cells. To the extent that these transmissions interfere with one another, reception by the mobile device 120 will be degraded.

In one embodiment of the instant invention, communications from neighboring base stations 130 are coordinated so that they occupy different time slots to transmit broadcast-multicast contents to avoid collisions or interference. The coordination may not need to be dynamic and certain time slot planning can be pre-configured before the system is started. Also, the synchronization requirement for such coordination is rather loose: the timing offset between neighboring base stations/sectors (including the propagation delay difference at the mobile) can be in a range of about 40 to 50 μs.

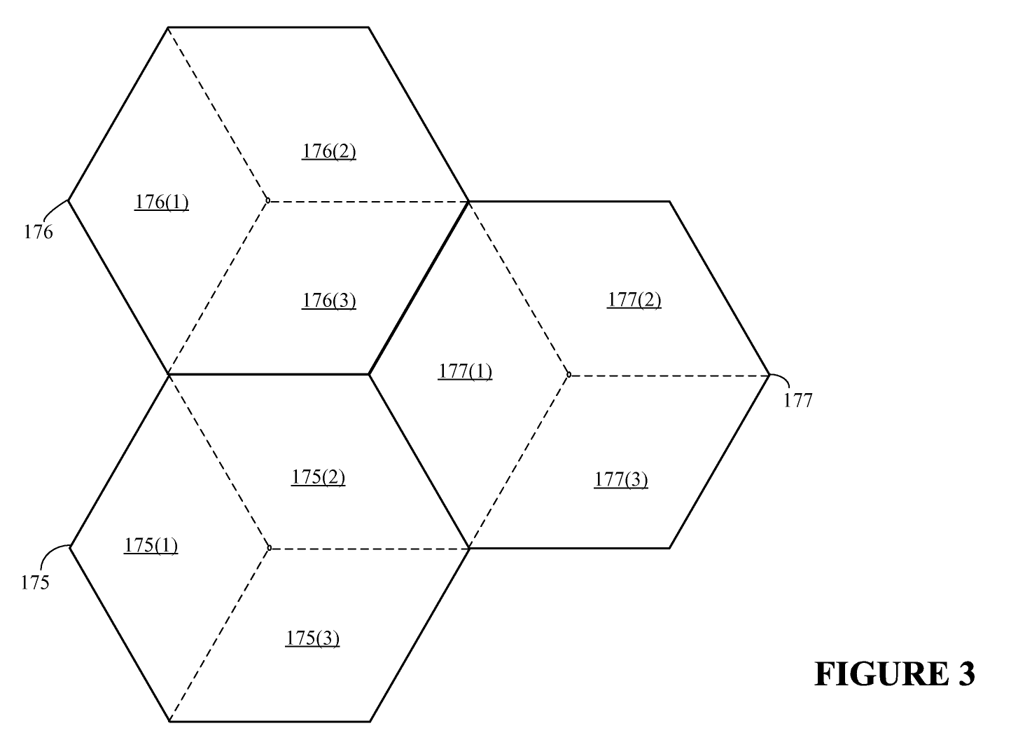

One example of a slot-reuse mechanism for EV-DO BCMCS that may be used to reduce interference between neighboring base stations 130 is shown in FIG. 4. In the illustrated embodiment, each of the three neighboring base stations/sectors occupies certain number of time slots. In the illustrated embodiment, which has a three-base station/sector configuration, the slot resource is configured such that each neighboring sector is assigned one-third of the slot resources, and thus, any interference from neighboring base stations 130 has to propagate twice the distance before reaching the affected mobile device 120, as compared to a case in which slot-reuse is not employed. Therefore, interference from neighboring sectors is significantly attenuated by the path loss, resulting in much higher signal-to-noise ration (SNR) for mobile devices 120 located near a cell edge.

A more detailed structure of a time slot is shown in a magnified region 400 in FIG. 4. In an occupied slot, such as slot 402, data fields, such as data field 404, are populated. When a slot is not occupied, such as slot 406, data fields are empty and pilot/MAC fields, such as field 408, remain on so that the mobile device 120 can monitor the pilot strengths from neighboring base stations/sectors for handoff purposes.

In one embodiment of the instant invention, the three base station/sector slot-reuse is applied to a four-interlace structure employed in an EV-DO forward link, by assigning Sector 1, Sector 2, and Sector 3 to occupy the first, second and third interlace, respectively. The fourth interlace of the EV-DO forward link is transmitted in Sector 1 during the first 12 time slots, in Sector 2 during the next 12 time slots, and in Sector 3 during the further next 12 time slots, and so on, as FIG. 4 shows. Therefore, each sector occupies a third of total slot-resource, on average. Those skilled in the art will appreciate that choosing a 12-slot period accommodates the maximum number of transmissions of 3 in Enhanced BCMCS.

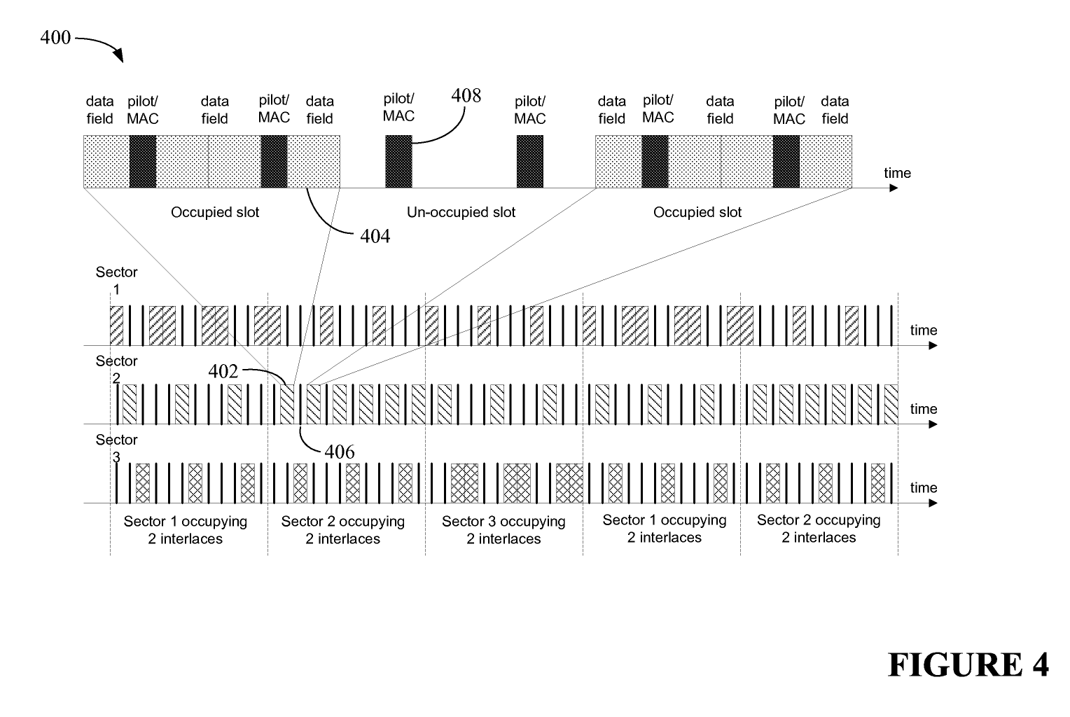

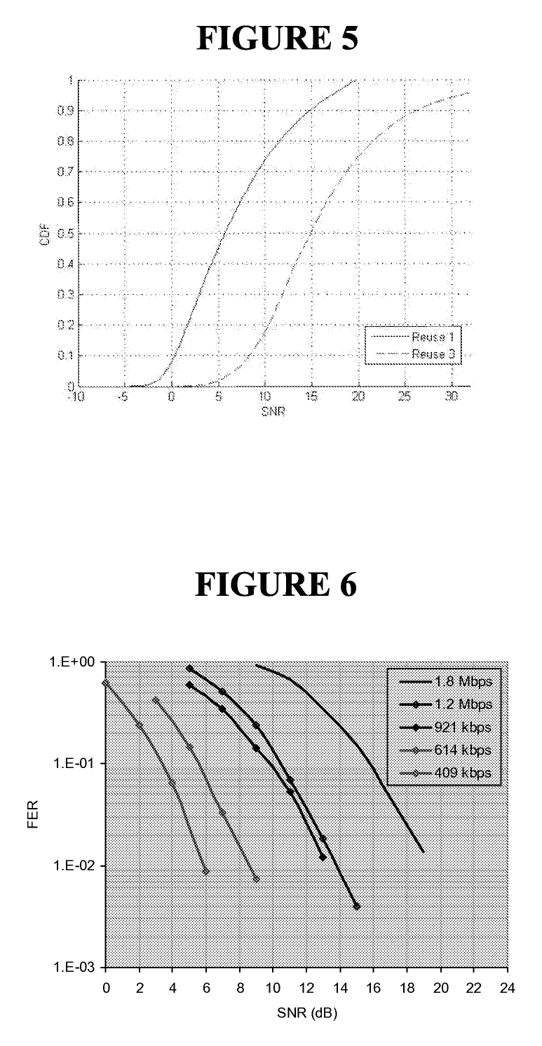

FIG. 5 shows a cumulative distribution function (CDF) of the SNR of a mobile device 120 in a slot-reuse case, as compared with no slot-reuse case. For BCMCS service, the SNR for mobile devices 120 located near a cell-edge is a significant indicator of performance. For example, the cell-edge SNR is sometimes considered as an accurate indicator of the coverage percentage for a certain data rate. Cell-edge SNR statistics correspond to the low percentile region in SNR CDF curves. As shown in FIG. 5, at 10 percentile, the SNR improvement by slot-reuse is approximately 8 dB. The required SNR for different data rates is shown in FIG. 6. At a frame error rate of 1%, 409 kbps and 614 kbps require 6 dB and 8.4 dB SNR, respectively, which can be supported with slot-reuse configuration with coverage of 90%, based on FIG. 5.

In the illustrated embodiment, each sector of the base station 130 can use only one-third of the slot resource. Thus, on a per-sector basis, the data rate is one-third of the rates listed in FIG. 6. That is, a data rate of 204.7 (614/3) kbps can be supported for each sector with coverage of about 90% at a frame error rate of about 1%. Thus, slot-reuse produces a significant gain. Otherwise, the 10 percentile SNR is only about 0 dB which cannot support 409 kbps.

SNR at cell edges is significantly improved so that the systems can support high data rate with good coverage, especially for broadcast-multicast service where the forward link coverage is a significant performance metric by service providers. With the slot-reuse pattern described in FIG. 4, data rates of broadcast-multicast users may be more homogeneous, regardless of whether they are close to the base station 130 or at a cell boundary.

To further improve efficiency, it may be useful to employ a dynamic slot-reuse allocation rather than the fixed method described above. In situations where dynamic slot-reuse is implemented, those skilled in the art will appreciate that coordination between the base stations 130 may be used to avoid slot-usage collisions. Such coordination may be accomplished by communications directly between the various base stations or through intermediary devices, such as the RNC.

Those skilled in the art will appreciate that the various system layers, routines, or modules illustrated in the various embodiments herein may be executable control units (such as the controllers 210, 250 (see FIG. 2)). The controllers 210, 250 may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by the controllers 210, 250 cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. Consequently, the method, system and portions thereof and of the described method and system may be implemented in different locations, such as the wireless unit, the base station, a base station controller and/or mobile switching center. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. It is therefore evident that the particular embodiments disclosed above may be altered or modified and all such variations are considered within the scope and spirit of the invention. Accordingly, the protection sought herein is as set forth in the claims below.

We claim:

1. A method for controlling a communications system, comprising:
targeting a transmission from a base station into a first sector of a cell during a first selected portion of a communications period;
targeting a transmission from the base station into a second sector of the cell during a second selected portion of the communications period; and
targeting a transmission from the base station into a third sector of the cell during a third selected portion of the communications period.

2. A method, as set forth in claim 1, wherein targeting the transmission from the base station into the first sector of the cell during the first selected portion of the communications period further comprises targeting the transmission from the base station into the first sector of the cell exclusively during the first selected portion of the communications period.

3. A method, as set forth in claim 1, wherein targeting the transmission from the base station into the second sector of the cell during the second selected portion of the communications period further comprises targeting the transmission from the base station into the second sector of the cell exclusively during the second selected portion of the communications period.

4. A method, as set forth in claim 1, wherein targeting the transmission from the base station into the third sector of the cell during the second selected portion of the communications period further comprises targeting the transmission from the base station into the third sector of the cell exclusively during the third selected portion of the communications period.

5. A method, as set forth in claim 1, wherein targeting the transmission from the base station into the first sector of the cell during the first selected portion of the communications period further comprises populating data fields in the transmission during the first selected portion of the communications period.

6. A method, as set forth in claim 5, wherein targeting the transmission from the base station into the first sector of the cell during the first selected portion of the communications period further comprises transmitting pilot signals into the first sector throughout the communications period.

7. A method, as set forth in claim 1, wherein the communications period is comprised of twelve slots, and the first, second and third selected portions of the communications period are comprised of at least one of three slots and six slots.

8. A method, as set forth in claim 1, wherein the communications period is comprised of twelve slots and the first, second and third selected portions of the communications period controllably varies between three slots and six slots on a periodic basis.

9. A method, as set forth in claim 8, wherein one of the first, second and third selected portions of the communications period is comprised of six slots and the remaining two of the first, second and third selected portions of the communications period are each comprised of three slots.

10. A method for controlling a communications system employing a four-interlace structure, comprising:
targeting a transmission of the first interlace from a base station into a first sector of a cell during a first selected portion of a communications period;
targeting a transmission of the second interlace from the base station into a second sector of the cell during a second selected portion of the communications period; and
targeting a transmission of the third interlace from the base station into a third sector of the cell during a third selected portion of the communications period; and
targeting a transmission of the fourth interlace from the base station into one of the first, second and third sectors of the cell during one of the first, second and third selected portions of the communications period, respectively.

11. A method, as set forth in claim 10, wherein targeting the transmission of the fourth interlace from the base station into one of the first, second and third sectors of the cell during one of the first, second and third selected portions of the communications period, respectively, further comprises controllably varying the targeting of the transmission of the fourth interlace from the base station into one of the first, second and third sectors of the cell.

12. A method, as set forth in claim 10, wherein targeting the transmission of the fourth interlace from the base station into one of the first, second and third sectors of the cell during one of the first, second and third selected portions of the communications period, respectively, further comprises periodically varying the targeting of the transmission of the fourth interlace from the base station into one of the first, second and third sectors of the cell.

13. A method, as set forth in claim 10, wherein targeting the transmission of the fourth interlace from the base station into one of the first, second and third sectors of the cell during one of the first, second and third selected portions of the communications period, respectively, further comprises serially varying the targeting of the transmission of the fourth interlace from the base station into the first, second and third sectors of the cell.
